(19) United States
(12) Patent Application Publication
(10) Pub. No.: US 2008/0273962 A1
(43) Pub. Date: Nov. 6, 2008

(54) Liquid Turbine Device Including a Turbine Wheel with More Than One Set of Blades in Radial Succession

(76) Inventors: Egil Andersen, Haugesund (NO); Stig Bakke, Algard (NO); Espen Osaland, Sandnes (NO)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/660,833

(22) PCT Filed: Aug. 19, 2005
(86) PCT No.: PCT/NO2005/000299

§ 371 Date: Oct. 30, 2007

(30) Foreign Application Priority Data
Aug. 25, 2004 (NO) 20043558

(51) Int. Cl. F03B 3/04; F03B 13/22; F01D 1/20

(52) U.S. Cl. 415/62; 415/68; 416/175; 416/201 R

(57) ABSTRACT

A liquid turbine device including a turbine wheel, in which the turbine wheel includes more than one set of blades in radial succession.

A liquid turbine device including a turbine wheel with more than one set of blades in radial succession.

This invention relates to a turbine. More particularly, it relates to a liquid turbine including more than one set of blades in radial succession. The turbine according to the invention is particularly suitable for, but not limited to, use in a wave-power device.

When liquid is used to drive a turbine, in which the liquid comes from different height levels, it is usual to arrange one turbine for each liquid reservoir. Thereby, the turbine can be adapted to the pressure head and flow rate in question, in order to have the best possible utilization of the available energy.

Norwegian patent 312327 discloses a wave-power device, in which several reservoirs are arranged on different height levels.

In reservoirs of this kind, where the reservoirs are arranged one above the other, a turbine solution according to the prior art will be relatively space-demanding and expensive.

It is also a considerable disadvantage that the turbines will have to be stopped and started every time a reservoir is emptied of liquid.

The invention has as its object to remedy or reduce at least one of the drawbacks of the prior art.

The object is achieved in accordance with the invention through the features specified in the description below and in the subsequent Claims.

By furnishing a turbine wheel with more than one set of blades in radial succession, it is possible to supply liquid from more than one reservoir to respective, corresponding sets of blades in the turbine wheel. Each individual set of blades is adapted to the prevailing pressure head and flow rate from the reservoir in question.

It is advantageous, but not decisive for the function of the turbine that concentric supply pipes connect the individual reservoirs to corresponding sets of blades in the turbine.

Preferably, cylindrically shaped plate portions separate the sets of blades, the diameter of the supply pipes corresponding to the adjacent plate portions.

Seals according to the prior art known per se may be arranged between the supply pipes and the turbine wheel.

On its underside, the turbine wheel is provided with outlet funnels extending down into a liquid below the turbine wheel.

In an alternative embodiment the one or more pipes extending from one reservoir to a corresponding set of blades may form flow lines between the reservoirs and the turbine wheel.

The supply pipes may be provided with control valves with the aim of controlling the liquid flow from at least one of the reservoirs to the turbine wheel.

In what follows, there is described a non-limiting example of a preferred embodiment, which is visualized in the accompanying drawings, in which:

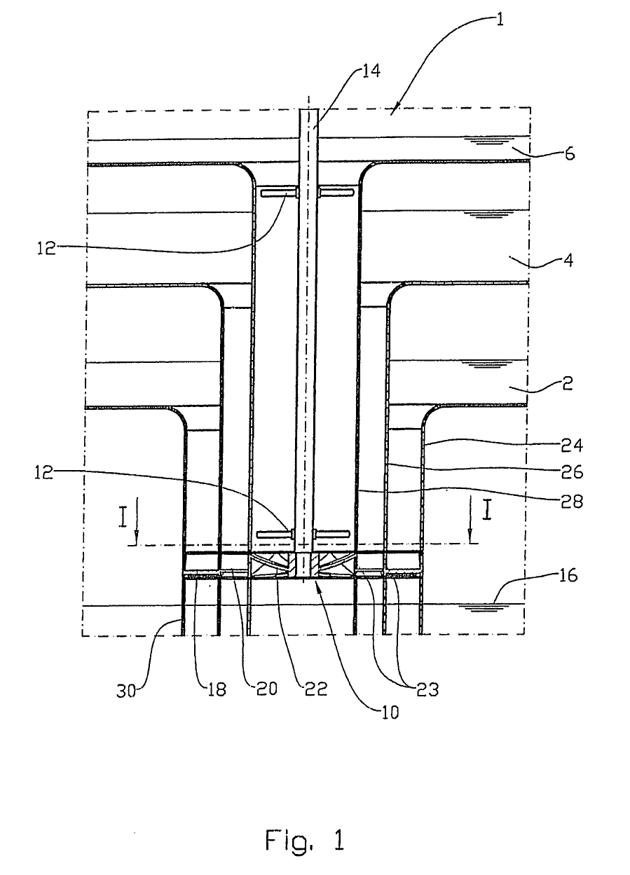

FIG. 1 shows schematically, in a vertical section, a turbine wheel according to the invention, which is connected by means of concentric pipe bores to reservoirs at different height levels; and

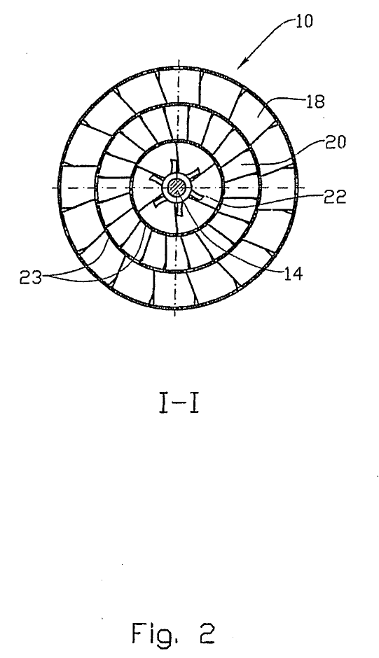

FIG. 2 shows schematically a section I-I of FIG. 1.

In the drawings the reference numeral 1 identifies a wave-power device including first, second and third reservoirs marked 2, 4 and 6, respectively. In FIG. 1 only part of the wave-power device is shown.

The reservoirs 2, 4, 6 are supplied with water via openings not shown.

A turbine wheel 10, which is connected to a vertical turbine shaft 14 running in bearings 12, is placed near the sea level 16.

In its radial direction, the turbine wheel 10 is provided with an outer set of blades 18, an intermediate set of blades 20 and an inner set of blades 22. The sets of blades 18, 20 and 22 are separated from each other by means of cylindrically shaped plate portions 23.

The reservoirs 2, 4 and 6 are connected to their respective sets of blades 18, 20 and 22 by means of concentric pipes 24, 26 and 28, an annular space between an outer pipe 24 and an intermediate pipe 26 forming a flow path from the first reservoir 2 to the outer set of blades 18. An annular space between the intermediate pipe 26 and an inner pipe 28 forms a flow path from the second reservoir 4 to the intermediate set of blades 20, whereas water from the third reservoir can flow to the inner set of blades via the inner pipe 28.

Concentric outlet funnels 30 are arranged on the underside of the turbine wheel 10.

Each of the sets of blades 18, 20, 22 can be formed in accordance with known principles of designing turbine blades, the blades 18, 20, 22 needing to be adapted for a common rotational speed about the turbine shaft 14.

1. A liquid turbine device including a turbine wheel where the turbine wheel includes more than one set of blades in radial succession, wherein at least two of the sets of blades each communicates with separate supply pipes.

2. The device in accordance with claim 1, wherein each of the sets of blades is adjusted to the prevailing pressure head and flow rate.

3. The device in accordance with claim 1, wherein the sets of blades are separated from each other by means of cylindrically shaped portions.

4. The device in accordance with claim 3, wherein the diameter of the pipes corresponds to the adjacent portions.

5. The device in accordance with claim 1, wherein the pipes are concentric.

6. The device in accordance with claim 1, wherein the turbine wheel is provided with outlet funnels on its underside.

7. The device in accordance with claim 1, wherein the pipes are provided with control valves to control the liquid flow from at least one of the reservoirs to the turbine wheel.
